(19) United States
(12) Patent Application Publication
(10) Pub. No.: US 2024/0317980 A1
(43) Pub. Date: Sep. 26, 2024

(54) THERMOPLASTIC VULCANIZATES WITH DYNAMICALLY CROSSLINKABLE POLYMERIC COMPOSITIONS

(71) Applicant: Braskem S.A., Camaçari (BR)

(72) Inventors: Murilo Lauer Sanson, São Paulo City (BR); Nei Sebastião Domingues Junior, São Paulo City (BR)

(73) Assignee: Braskem S.A., Camaçari (BR)

(21) Appl. No.: 18/592,867

(22) Filed: Mar. 1, 2024

Related U.S. Application Data
(60) Provisional application No. 63/449,215, filed on Mar. 1, 2023.

(51) Int. Cl. C08L 23/08; B29B 7/00; C08L 23/06; C08L 23/12

(52) U.S. Cl. CPC C08L 23/0853; B29B 7/005; B29B 7/007; C08L 23/06; C08L 23/12; C08L 2205/02; C08L 2207/04; C08L 2207/062

(57) ABSTRACT

A polymer blend composition may include from 0.01 to 99.99 wt % of a thermoplastic resin matrix; and from 0.01 to 99.99 wt % of a dynamically crosslinked polymer. A thermoplastic vulcanizate composition may include from 0.01 to 99.99 phr of a thermoplastic resin; from 0.01 to 99.99 phr of a dynamically crosslinked polymer; from 0 to 150 phr of plasticizer; and from 0 to 600 phr of at least one filler.

### BACKGROUND

Thermoplastic vulcanizates (TPVs) are compositions containing a crosslinked elastomer, a thermoplastic, and other useful additives for such compositions (such as dyes, pigments, fillers, reinforcing agents (such as particles, fibers, whiskers, etc.), oils, etc.), which aim to present rubber-like properties in a composition that can be processable and recyclable (due to the thermoplastic matrix). They are conventionally produced via reactive extrusion, where the process of “dynamic vulcanization” of the rubber is carried out. During this dynamic vulcanization, the morphology of the blend is developed (with a goal of having the rubber as a dispersed phase, as droplets, in the thermoplastic matrix) and the elastomeric phase is crosslinked. The final composition can achieve a broad range of properties, depending on the properties of and ratio of matrix and elastomer, the crosslinking density of the elastomeric phase, the processing conditions and the amount and type of additives. After the reactive extrusion and pelletizing, the TPV can be further molded. Most commonly, the TPV is extruded into profiles (e.g., scaling profiles for automotive applications, tubes and hoses, etc.), or injection or compression molded into different articles, including gaskets, automotive parts (such as bushings, couplers, engine and transmission mounts, pulleys, etc.), other sealing systems, dampeners, electrical insulators, sporting goods, multiple consumer goods such as toys, cookware, etc.

However, TPV production faces issues, mainly related to the dynamic vulcanization. Some of the most used crosslinking systems include sulfur and accelerators, organic peroxides and phenolic resins (phenolic resins being the most common). The use of peroxide crosslinking system can lead to degradation to the matrix (e.g. β-scission of polypropylene—the most common matrix for TPVs, or crosslinking if the matrix is prone to it); phenolic resins are difficult to feed and can lead to coloration and hygroscopic properties to the compound; and sulfur and accelerators do not provide the most thermally stable crosslinks and can lead to odor issues. Moreover, the blend development process is complex, especially in higher rubber contents, as the process of phase inversion and droplet break-up (in a much less viscous matrix) happens during crosslinking, which demands a very specialized knowledge, extruders with a large L/D and high precision equipment for feeding the crosslinking system.

Thus, it would be beneficial to make this process simpler and faster. For example, if the rubber/elastomer was already crosslinked, the processing would be much simpler, possibly demanding extruders with lower L/D and would not demand crosslinking system feeding.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymer blend composition that includes from 0.01 to 99.99 wt % of a thermoplastic resin matrix; and from 0.01 to 99.99 wt % of a dynamically crosslinked polymer.

In one aspect, embodiments disclosed herein relate to a thermoplastic vulcanizate composition that includes from 0.01 to 99.99 phr of a thermoplastic resin; from 0.01 to 99.99 phr of a dynamically crosslinked polymer; from 0 to 150 phr of plasticizer; and from 0 to 600 phr of at least one filler.

In another aspect, embodiments disclosed herein relate to an article that includes a polymer blend composition that includes from 0.01 to 99.99 wt % of a thermoplastic resin matrix; and from 0.01 to 99.99 wt % of a dynamically crosslinked polymer.

In another aspect, embodiments disclosed herein relate to an article that includes a thermoplastic vulcanizate composition that includes from 0.01 to 99.99 phr of a thermoplastic resin; from 0.01 to 99.99 phr of a dynamically crosslinked polymer; from 0 to 150 phr of plasticizer; and from 0 to 600 phr of at least one filler.

In another aspect, embodiments disclosed herein relate a method that includes blending a thermoplastic resin and a dynamically crosslinked polymer to form a polymer blend composition that includes from 0.01 to 99.99 wt % of a thermoplastic resin matrix; and from 0.01 to 99.99 wt % of a dynamically crosslinked polymer.

In yet another aspect, embodiments disclosed herein relate to a method of forming an article that includes processing a polymer blend composition that includes from 0.01 to 99.99 wt % of a thermoplastic resin matrix; and from 0.01 to 99.99 wt % of a dynamically crosslinked polymer.

In yet another aspect, embodiments disclosed herein relate to a method of forming an article that includes processing a thermoplastic vulcanizate composition that includes from 0.01 to 99.9 phr of a thermoplastic resin; from 0.01 to 99.9 phr of a dynamically crosslinked polymer; from 0 to 150 phr of plasticizer; and from 0 to 600 phr of at least one filler.

Other aspects and advantages of the claimed subject matter will be apparent from the following description and the appended claims.

### BRIEF DESCRIPTION OF DRAWINGS

FIGS. 1 and 2 show torque plots for formulations based on HDPE and PP, respectively.

FIGS. 3-6 show the morphology for PP based formulations.

FIGS. 7-10 show the morphology for HDPE based formulations.

FIGS. 11-13 show DMA analysis with a temperature sweep for PP based formulations.

FIGS. 14-16 show DMA analysis with a temperature sweep for HDPE based formulations.

FIGS. 17-19 show DMA analysis with a frequency sweep for PP based formulations.

FIGS. 20-22 show DMA analysis with a frequency sweep for HDPE based formulations.

FIGS. 23 and 24 show viscosity and elasticity ratio of PP based formulations and DXL EVA for a low and a high angular frequency.

FIGS. 25 and 26 show viscosity and elasticity ratio of HDPE based formulations and DXL EVA for a low and a high angular frequency.

FIG. 27 shows full time vs torque and temperature for a dynamically crosslinked EVA.

FIG. 28 shows an image of physical samples of a dynamically crosslinked EVA.

### DETAILED DESCRIPTION

Embodiments disclosed herein relate to polymeric compositions, methods of forming such polymeric compositions, and articles formed from such polymeric compositions. The polymeric compositions may be thermoplastic vulcanizates (TPVs) that include a thermoplastic matrix and, as the rubber phase, a dynamically crosslinked polymer comprising at least one monomer selected from the group consisting of vinyl esters, C2-C12 olefins, and combinations thereof that are dynamically crosslinked.

In particular, embodiments disclosed herein relate to a TPV that incorporates therein dynamically crosslinked polymers (such as EVA) produced prior to the TPV processing, as the rubber phase of the TPV, which advantageously behaves as a viscous thermoplastic at high temperatures (e.g. >150° C.), making compounding much simpler.

### Thermoplastic Vulcanizates

As mentioned above, conventionally, thermoplastic vulcanizates are a blend of a thermoplastic resin into which a rubber phase is dispersed and crosslinked (or vulcanized) during blending/processing, thereby forming dispersed crosslinked rubber particles in a continuous thermoplastic matrix phase. Similarly, the present disclosure relates to a composition that includes a thermoplastic matrix and a dispersed rubber phase of a dynamically crosslinked polymer. Each of these will be discussed in turn.

In one or more embodiments, the rubber phase is crosslinked (through dynamic crosslinks) prior to being blended or melt processed with the thermoplastic matrix phase. Alternatively, the crosslinked polymer phase might be formed during a traditional reactive processing (as it is performed in conventional TPV technologies), where the crosslinking system (which might comprise a crosslinker and a catalyst) is fed in the processing equipment (e.g. twin-screw extruder or a batch mixer), selectively crosslinking the desired phase. Such embodiments may be applicable where crosslinking is selective towards the dynamically crosslinkable polymer, not affecting the thermoplastic matrix. Thus, such embodiments do not extent to, matrices with functional groups that would react with the crosslinking system.

### Thermoplastic Matrix Phase

In one or more embodiments the thermoplastic resin matrix comprises at least one thermoplastic selected from polyolefins (e.g. Ethylene Vinyl Acetate copolymer, polypropylene, polyethylenes, copolymers of ethylene, propylene and other alpha-olefins, etc.); acrylonitrile butadiene styrene (ABS) and other specialist styrenics co and terpolymers; cellulosics thermoplastics; polyacrylamides and copolymers of acrylamides; polystyrene and derivatives; thermoplastic polyurethanes; fluoroplastics (e.g. PTFE, FEP); polyamides; aromatic polyamides; polyketones (e.g. PEEK™ (polyaryletheretherketone)); polybutene; polycarbonate; polyacetals (e.g. POM); poly(vinyl acetate); polyesters (e.g. PETP, PBT, PET, PBAT, PLA, etc.); polyethylene oxide, polypropylene oxide, polyphenylene oxide; polyphenylene sulphide; polymethylpentene; poly(vinyl alcohol) (PVOH, PVA, or PVAI); ethylene vinyl alcohol (EVOH) copolymers; polyvinyl chloride; styrene acrylonitrile and acrylonitrile styrene acrylate; thermoplastic elastomers; among other useful thermoplastics; and combinations thereof. For example, polyolefins may be selected from ethylene homopolymers, copolymer of ethylene and one or more C3-C12 alpha olefins, propylene homopolymer, copolymers of propylene and one or more comonomers selected from ethylene, C4-C12 alpha-olefins and combinations thereof, ethylene vinyl acetate, other ethylene based co- and terpolymers and combinations thereof. Such polymers may virgin or recycled materials. Moreover, one or more monomers may be formed from a fossil feedstock or a renewable (biobased) feedstock. Thus, in one or more even more particular embodiments, the thermoplastic polymer may be a biobased polymer, especially ethylene vinyl acetate and polyethylene, where, for example, ethylene might be derived from biobased ethanol.

In one or more embodiments, the thermoplastic resin matrix is present in an amount ranging from a lower limit of any of 0.01 wt %, 1 wt %, 5 wt %, 10 wt %, 15 wt %, 20 wt %, 25 wt %, or 50 wt %, and an upper limit of any of 25 wt %, 50 wt %, 70 wt %, 80 wt %, 90 wt %, 99 wt %, or 99.99 wt % of combination of the thermoplastic resin matrix and the dynamically crosslinked polymer, i.e., a blend of the two components.

### Dynamically Crosslinked Polymer

As mentioned above, a dynamically crosslinked polymer may be dispersed in the thermoplastic matrix. The dynamically crosslinked polymer may be a polymer comprising at least one monomer selected from the group consisting of vinyl esters, C2-C12 olefins, and combinations thereof that are dynamically crosslinked. For example, it is envisioned that the dynamically crosslinked polymer may include those described in U.S. patent application Ser. No. 17/901,677, which is herein incorporated by reference in its entirety.

The dynamic crosslinks may be dynamic covalent bonds that can undergo associative exchange reactions, such that the network topology is able to change, the material relaxes stresses and flows, while keeping the crosslinking density constant. Dynamically crosslinked systems exhibit the characteristics of crosslinked materials at ambient temperatures (high chemical resistance, exceptional mechanical properties), while they can be processed or reprocessed in a similar fashion as thermoplastic materials at elevated temperatures.

The dynamically crosslinked polymer may be prepared by mixing a polymer and a crosslinking system. The crosslinking system may comprise a crosslinking agent and a catalyst. The polymer may comprise a dynamic crosslinking group and/or a dynamic crosslinking group may be grafted thereto. Crosslinking of the polymer may include processing that is conducted above the melting or softening temperature of the composition to trigger crosslinking of the polymer.

In one or more embodiments, the polymer includes at least one monomer selected from C2-C12 olefins, a vinyl ester, and combinations thereof. The olefins may comprise one or more of ethylene, 1-propene, 1-butene, 1-pentene, 1-hexene, 1-heptene, 1-octene, 1-nonene, 1-decene, 1-undecene, 1-dodecene and combinations thereof. Thus, for example, it is envisioned that the polymer may include polymers such as polyolefins, including ethylene homopolymers, copolymer of ethylene and one or more C3-C12 alpha olefins, propylene homopolymer, copolymers of propylene and one or more comonomers selected from ethylene, C4-C12 alpha-olefins and combinations thereof, ethylene vinyl acetate, poly(vinyl acetate), and combinations thereof. In copolymers of an olefin and vinyl ester(s), it is envisioned that the vinyl ester(s) may be present as comonomers in an amount ranging from a lower limit of 1, 5, 10, 15, 18, or 20 wt %, to an upper limit of any of 25, 40, 60, or 80 wt % of the total mass of the copolymer. In one or more particular embodiments, vinyl acetate may be used as monomer or comonomer. In one or more even more particular embodiments, the polymer may be a biobased polymer, especially ethylene vinyl acetate and polyethylene, where, for example, ethylene might be derived from biobased ethanol.

It is also envisioned that the polymer may include a branched vinyl ester comonomer (in combination with ethylene alone to form a copolymer or in combination with ethylene and vinyl acetate to form a terpolymer). Such copolymer and terpolymers are described in U.S. Pat. No. 11,326,002, which is herein incorporated by reference in its entirety. For example, such branched vinyl ester monomers may include monomers having general structure (I):

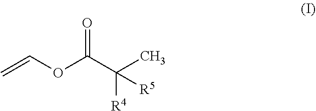

wherein R4 and R5 have a combined carbon number of 6 or 7. However, it is also envisioned that the other branched vinyl esters described in U.S. Pat. No. 11,326,002 may be used.

In one or more embodiments, the dynamically crosslinked polymer is present in an amount ranging from a lower limit of any of 0.01 wt %, 1 wt %, 5 wt %, 10 wt %, 15 wt %, 20 wt %, 25 wt %, or 50 wt %, and an upper limit of any of 25 wt %, 50 wt %, 70 wt %, 80 wt %, 90 wt %, 99 wt %, or 99.99 wt % of combination of the thermoplastic resin matrix and the dynamically crosslinked polymer, i.e., a blend of the two components.

In referring to a polymer that forms the dynamically crosslinked polymer described herein, it is intended that the polymer is dynamically crosslinked via a dynamic crosslinking group and addition of a crosslinking system. The dynamic crosslinking group may be incorporated into the polymer during polymerization, for example the vinyl esters of EVA, or the dynamic crosslinking group may be added to a base polymer after the base polymer has been polymerized. The dynamic crosslinking group may be added to a base polymer via for example a grafting reaction during a reactive processing step to form the thermoplastic polymer. The grafting reaction may comprise forming at least one covalent bond between a base polymer and a molecule containing a dynamic crosslinking group. Grafting may include, for example, melt grafting, solution grafting, or solid state grafting.

In one or more embodiments, the dynamically crosslinked polymer exhibits improved solvent resistance compared to an uncrosslinked blend. For example, withstanding exposure to THF at room temperature while exhibiting moderate swelling (compared to peroxide cured polymers) for over 168 hours, meanwhile uncrosslinked polymers (e.g. neat EVA), solubilize almost totally in less than 48 hours. In addition, some compositions might also present solvent resistance to boiling xylene up to 12 hours, presenting high gel content-over 70 wt %-measuring according to ASTM D2765-16.

In one or more embodiments, the dynamically crosslinked polymer exhibits Shore A Hardness (measured according to ASTM D2240) ranging from 20-90 Asker C, 30-95 Shore A, or 30-90 Shore D, preferably from 50-90 Shore A.

In one or more embodiments, the dynamically crosslinked polymer exhibits density from 0.9-2 g/cm³, preferably from 0.9-1.7 g/cm³, as measured by ASTM D792 or ASTM D297.

In one or more embodiments, the dynamically crosslinked polymer exhibits stress at break from 0.1 to 200 MPa, preferably from 5 to 30 MPa, according to DIN 53504.

In one or more embodiments, the dynamically crosslinked polymer exhibits strain at break from 50 to 2500%, preferably from 800 to 2200%, according to DIN 53504.

### Dynamic Crosslinking Group

As mentioned above, the crosslinking may be achieved via a dynamic crosslinking group or moiety present in the polymer. In one or more embodiments, the dynamic crosslinking group may be selected from the group consisting of esters, epoxides, organic acids, alcohols, anhydrides, amines, amides, cyanates, unsaturated hydrocarbons, and combinations thereof.

As also mentioned above, the moiety or dynamic crosslinking group may be present in the polymer from polymerization (such as in the case of an ester in thermoplastics containing vinyl ester monomers) or such moiety may be reacted with a base polymer via a post-polymerization reactive processing to form the thermoplastic polymer. Such reacting processing may include, for example, melt grafting, solution grafting, or solid state grafting. It is also envisioned that the dynamic crosslinking group may be the same or different chemical species as a monomer forming the polymer. For example, in the case of the polymer being polyvinyl acetate, the vinyl acetate is both a monomer and a dynamic crosslinking group.

In one or more embodiments, the dynamic crosslinking group may include vinyl esters such as vinyl acetate, vinyl propionate, vinyl 2-ethylhexanoate, vinyl decanoate, vinyl neodecanoate, vinyl neononanoate, vinyl laurate, vinyl benzoate, vinyl pivalate, vinyl butyrate, vinyl trifluoroacetate, vinyl cinnamate, vinyl 4-tert-butylbenzoate, vinyl stearate, allyl cinnamate, vinyl methacrylate, and the like, and combinations thereof.

In one or more embodiments, the dynamic crosslinking group may include unsaturated organic acids, such as itaconic acid, maleic acid, acrylic acid, crotonic acid, methacrylic acid, fumaric acid, 1-Vinyl-1H-pyrrole-2-carboxylic acid, 1,2-Benzenedicarboxylic acid, and the like, and combinations thereof.

In one or more embodiments, the dynamic crosslinking group may include unsaturated epoxides, such as glycidyl methacrylate, 4-vinyl-1-cyclohexene 1,2-epoxide, Allyl glycidyl ether, 1,2-Epoxy-5-hexene, 3,4-Epoxy-1-butene, 3,4-Epoxy-1-cyclohexene, 2-Methyl-2-vinyloxirane, 1,2-Epoxy-9-decene, and the like, and combinations thereof.

In one or more embodiments, the dynamic crosslinking group may include unsaturated alcohols, such as allyl alcohol, 3-buten-1-ol, 2-Methyl-2-propen-1-ol, 3-Methyl-3-buten-1-ol, 3-Buten-2-ol, 3-Methyl-2-buten-1-ol, 2-Methyl-3-buten-2-ol, Crotyl alcohol and the like, and combinations thereof.

In one or more embodiments, the dynamic crosslinking group may include unsaturated anhydrides, such as maleic anhydride, citraconic anhydride, itaconic anhydride, (2-Dodecen-1-yl)succinic anhydride, and the like, and combinations thereof.

In one or more embodiments, the dynamic crosslinking group may include unsaturated amines, such as trans-dimethyl-(4-(2-p-tolyl-vinyl)-benzyl)-amine, [4-((e)-2-benzothiazol-2-yl-vinyl)-phenyl]-diethyl-amine, 2-methyl-1-vinylimidazole, 4-vinylpyridine, 2-vinylpyrazine, 2-vinylpyridine, 4-vinylaniline, 3-vinylaniline, allylamine, 3-buten-1-amine, n-allylmethylamine, n-vinylformamide, 2-methyl-2-propen-1-amine, and the like, and combinations thereof.

In one or more embodiments, the dynamic crosslinking group may comprise a moiety able to react with the dynamic crosslinking system. In one or more embodiments, the dynamic crosslinking group is present in the polymer in amounts up to 100 wt %, 90 wt %, 70 wt %, 50 wt %, 30 wt %, 10 wt %, 5 wt %, 4 wt %, 3 wt %, 2 wt %, 1 wt %, 0.05 wt %, or 0.01 wt % of the polymer.

### Dynamic Crosslinking System

In one or more embodiments, the dynamic crosslinking system may comprise a dynamic crosslinking agent able to react with the dynamic crosslinking group and optionally a catalyst. In one or more embodiments, the dynamic crosslinking system is present in the polymeric composition in amounts up to 40 wt %, 30 wt %, 25 wt %, 20 wt %, 15 wt %, 10 wt %, 5 wt %, 4 wt %, 3 wt %, 2 wt %, 1 wt %, 0.05 wt %, or 0.01 wt % of the polymeric composition.

### Dynamic Crosslinking Agent

In one or more embodiments, the dynamic crosslinking agent may be able to react with ester, epoxide, organic acids, alcohols, anhydrides, amines, amides, cyanates and/or unsaturated hydrocarbons groups to form reversible covalent bonds. The dynamic crosslinking agent may be selected from borates, silanes, polyamines, polyalcohols, polyols, polyacids, anhydrides, and combinations thereof.

In one or more embodiments, the dynamic crosslinking agent may include borates such as triethyl borate, trimethyl borate, tributyl borate, triphenyl borate, tris(trimethylsilyl) borate, tri-tert-butyl borate, triallyl borate, trihexyl borate, trioctyl borate, tribenzyl borate, triisopropyl borate, tris(2,2,2-trifluoroethyl) borate, tris(2-ethylhexyl) borate, and the like, and combinations thereof.

In one or more embodiments, the dynamic crosslinking agent may include silanes such as tetrapropyl orthosilicate (TPOS), tetraethyl orthosilicate (TEOS), tetrabutyl orthosilicate (TBOS), tetrapentyl orthosilicate, vinyltriethoxysilane, vinyltrimethoxysilane, allyltriethoxysilane, vinyl-tri-n-butoxysilane, hexenyltri-iso-butoxysilane, allyltri-n-pentoxysilane, dodecenyltri-n-octoxysilane, heptenyltri-n-heptoxysilane, allyltri-iso-propoxysilane, pentenyltri-n-propoxysilane, secbutenyltriethoxysilane, 3-methacryloxypropyl-trimethoxysilane, γ-methacryloxypropyltrimethoxysilane and the like, and combinations thereof.

In one or more embodiments, the dynamic crosslinking agent may include polyamines-diamines triamines, or molecules containing multiple amines-such as hexamethylenediamine, 1,4-diaminobutane, ethylenediamine, 1,12-diaminododecane, 1,10-diaminodecane, tris(2-aminoethyl)amine, bis(hexamethylene)triamine, triethylenetetramine, tetraethylenepentamine, and the like, and combinations thereof.

In one or more embodiments, the dynamic crosslinking agent may include polyols-diols, triols, or molecules containing multiple alcohols-such as polycaprolactone diol, 1,6-hexanediol, 1,5-pentanediol, 1,4-butanediol, 1,10-decanediol, 1,2,6-hexanetriol, 1,2,3-hexanetriol, 1,4-heptanediol, 1,2,10-decanetriol, ethylenediamine tetrakis(ethoxylate-block-propoxylate) tetrol, 5-pregnene-3-beta, 11-beta, 17-alpha,20-beta-tetrol, and the like, and combinations thereof.

In one or more embodiments, the dynamic crosslinking agent may include polyacids-diacids, triacids or molecules containing multiple acids-such as 2-aminoterephthalic acid, maleic acid, fumaric acid, itaconic acid, terephthalic acid, 2-hydroxyterephthalic acid, trimesic acid, 1,3,5-tris(4-carboxyphenyl)benzene, and the like, and combinations thereof.

In one or more embodiments, the dynamic crosslinking agent may include anhydrides, dianhydrides, or molecules containing multiple anhydrides, such as maleic anhydride, citraconic anhydride, itaconic anhydride, (2-dodecen-1-yl)succinic anhydride, pyromellitic dianhydride, 3,3′,4,4′-biphenyltetracarboxylic dianhydride, and the like, and combinations thereof.

In one or more embodiments, the dynamic crosslinking agent may be present in the polymer composition from a lower limit of any of 0.01 wt %, 0.1 wt %, 0.5 wt %, 1 wt %, 2 wt %, or 3 wt %, and an upper limit of any of 4 wt %, 5 wt %, 6 wt %, 8 wt %, 10 wt %, 12 wt %, 15 wt %, 20 wt %, 25 wt % or 40 wt %, where any lower limit can be used in combination with any upper limit.

### Catalyst

In one or more embodiments, the dynamic crosslinking system optionally comprises a catalyst that facilitates the formation and exchange reactions for the dynamic crosslinks in the polymeric composition described above. In one or more embodiments, the catalyst may be a transesterification catalyst. In one or more embodiments, the catalyst is selected from o-nucleophiles, n-nucleophiles, metal oxides, metal hydroxides, acid/alkaline catalysts such as NaOH or KOH, organic metal salts selected from the group consisting of acetylacetonates, diacrylates, carbonates, acetates and combinations thereof and wherein the metal is selected from the group consisting of Zinc, Molybdenum, Copper, Magnesium, Sodium, Potassium, Calcium, Nickel, Tin, Lithium, Titanium, Zirconium, Aluminum, Lead, Iron, Vanadium, and combinations thereof.

In one or more embodiments, the catalyst may be selected from Bis(acetylacetonato)dioxomolybdenum(VI), dibutyltin oxide (DBTO), Triazabicyclodecene (TBD), 1,8-Diazabicyclo[5.4.0]undec-7-ene, 7-methyl-1,5,7-triazabicyclo[4.4.0]dec-5-ene (MTBD), Triphenylphosphine, 4-Dimethylaminopyridine (DMAP), double metal cyanaide (DMC), diphenyl carbonate (DPC), methyl phenyl carbonate (MPC), or combinations thereof, or other similar catalysts known in the art.

In one or more embodiments, the catalyst may be present in an amount greater than 0.1 mol %, 0.5 mol %, 1 mol %, 2 mol %, 5 mol %, 10 mol %, 25 mol % or 50 mol % relative to the dynamic crosslinking system. It is envisioned that it may be desirable to add catalyst in an amount sufficient to create dynamic crosslinks within the thermoplastic polymer in suitable processing conditions of time, temperature, shear rates, etc.

### Plasticizers

Thermoplastic vulcanizates in accordance with the present disclosure may contain one or more plasticizers to adjust the physical properties and processability of the composition. In some embodiments, plasticizers in accordance with the present disclosure may include one or more of bis(2-ethylhexyl) phthalate (DEHP), di-isononyl phthalate (DINP), bis (n-butyl) phthalate (DNBP), butyl benzyl phthalate (BZP), di-isodecyl phthalate (DIDP), di-n-octyl phthalate (DOP or DNOP), di-o-octyl phthalate (DIOP), diethyl phthalate (DEP), di-isobutyl phthalate (DIBP), di-n-hexyl phthalate, tri-methyl trimellitate (TMTM), tris (2-Ethylhexyl) Trimellitate (TOTM), tri-(n-octyl, n-decyl) trimellitate, tri-(heptyl, nonyl) trimellitate, n-octyl trimellitate, bis (2-ethylhexyl) adipate (DEHA), dimethyl adipate (DMD), mono-methyl adipate (MMAD), dioctyl adipate (DOA)), dibutyl sebacate (DBS), polyesters of adipic acid such as VIERNOL, dibutyl maleate (DBM), di-isobutyl maleate (DIBM), benzoates, epoxidized soybean oils and derivatives, n-ethyl toluene sulfonamide, n-(2-hydroxypropyl) benzene sulfonamide, n-(n-butyl) benzene sulfonamide, tricresyl phosphate (TCP), tributyl phosphate (TBP), glycols/polyesters, triethylene glycol dihexanoate, 3gh), tetraethylene glycol di-heptanoate, polybutene, acetylated monoglycerides; alkyl citrates, triethyl citrate (TEC), acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trihexyl o-butyryl citrate, trimethyl citrate, alkyl sulfonic acid phenyl ester, 2-cyclohexane dicarboxylic acid di-isononyl ester, nitroglycerin, butanetriol trinitrate, dinitrotoluene, trimethylolethane trinitrate, diethylene glycol dinitrate, triethylene glycol dinitrate, bis (2,2-dinitropropyl) formal, bis (2,2-dinitropropyl) acetal, 2,2,2-trinitroethyl 2-nitroxyethyl ether, lubricant, such as, stearic acid, silicones, anti-static amines, organic amities, ethanolamides, mono- and di-glyceride fatty amines, ethoxylated fatty amines, fatty acids, zinc stearate, stearic acids, palmitic acids, calcium stearate, zinc sulfate, mineral oils with a variety of chemical compositions such as naphthenic oils, aromatic oils, paraffinic oils, polyaromatic oils; liquid paraffins, vegetable or biobased oils such as soybean oil, linseed oil, and castor oil; oligomeric aromatic polyolefins; paraffinic waxes, including, for example, polyethylene waxes, and polypropylene waxes; synthetic oils, including, for example, silicone oils, alkyl benzenes (for example, dodecylbenzene, and di(octylbenzyl)toluene), aliphatic esters (including, for example, tetraesters of pentaerythritol, esters of sebacic acid, phthalic esters), olefin oligomers (including, for example, optionally hydrogenated polybutenes or polyisobutenes); among other oils, plasticizers, polymeric plasticizers, and the like and combinations thereof. In particular embodiments, one of the one or more plasticizers may be an ester-based oil.

Thermoplastic vulcanizate compositions in accordance with the present disclosure may optionally include plasticizers in an amount ranging from 0 to 150 phr of the thermoplastic vulcanizates (phr being per hundred resin, which is the combined amount of thermoplastic resin matrix and dynamically crosslinked polymer). The plasticizer may be present in an amount ranging from a lower limit of one of 0 phr, 1 phr, 5 phr, 10 phr, 20 phr, 50 phr, or 75 phr and an upper limit of one of 50 phr, 75 phr, 100 phr, 125 phr, or 150 phr of the polymer composition, where any lower limit may be combined with any mathematically compatible upper limit.

Thermoplastic vulcanizate compositions in accordance with the present disclosure may include at least one filler. For example, thermoplastic vulcanizate compositions may include one or more organic or inorganic filler such as talc, glass fibers, marble dust, cement dust, clay, carbon black, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium based oxides, calcium carbonate, graphene, carbon nanotube and other carbon based nanostructures, boron nitride nanotubes, wood powder, wood derivative particles, cellulose fibers and nanofibers, crystalline nanocellulose, cellulose nanofibers and other cellulose based nanostructures, other cellulose derivatives from diverse sources, lignin based materials and other natural fibers/fillers, and other nanoparticles, nanofibers, nanowhiskers, nanosheets, polyhedral oligomeric silsesquioxane (POSS), recycled EVA, and other recycled rubbers and plastic compounds that may or may not crosslinked. As defined herein, recycled compounds may be derived from end of life, used articles, or regrind materials that have undergone at least one processing method such as molding or extrusion and the subsequent sprue, runners, flash, rejected parts, and the like, are ground or chopped.

Thermoplastic vulcanizate compositions disclosed herein may optionally include at least one filler in an amount ranging from a lower limit of one of 0 phr, 1 phr, 5, phr, 10 phr, 50 phr, 100 phr, or 200 phr and an upper limit of one of 250 phr, 300 phr, 350 phr, 400 phr, 450 phr, 500 phr, 550 phr, or 600 phr of the thermoplastic vulcanizate compositions, where any lower limit may be combined with any mathematically compatible upper limit.

### Optional Additives

The thermoplastic vulcanizate compositions of the present disclosure may also include, in addition to the thermoplastic matrix and dynamically crosslinked polymer, one or more optional additives such as, but not limited to, permanent crosslinking agents and co-agents, foaming agents, foaming accelerants, elastomer, processing aids, mold releases, lubricants, dyes, pigments, antioxidants, light stabilizers, flame retardants, antistatic agents, antiblock additives, or other additives to modify the balance of stiffness and elasticity in the polymer composition, such as fibers, fillers, production scraps, nanoparticles, nanofibers, nanowhiskers, nanosheets, and other reinforcement elements or nanoelements. In some embodiments, one or more of such additives may be added during the initial mixing or melt processing of the thermoplastic matrix and dynamically crosslinked polymer, while in one or more embodiments, one or more of such additives may be compounded in a subsequent process step, after the thermoplastic vulcanizate composition has been formed.

For example, thermoplastic vulcanizate compositions in accordance with one or more embodiments of the present disclosure may include one or more elastomers. Elastomers in accordance with the present disclosure may include one or more of natural rubber, poly-isoprene (IR), styrene and butadiene rubber (SBR), polybutadiene, nitrile rubber (NBR); polyolefin rubbers such as ethylene-propylene rubbers (EPDM, EPM), and the like, acrylic rubbers, halogen rubbers such as halogenated butyl rubbers including brominated butyl rubber and chlorinated butyl rubber, brominated isotubylene, polychloroprene, and the like; silicone rubbers such as methylvinyl silicone rubber, dimethyl silicone rubber, and the like, sulfur-containing rubbers such as polysulfidic rubber; fluorinated rubbers; thermoplastic rubbers such as elastomers based on styrene, butadiene, isoprene, ethylene and propylene, styrene-isoprene-styrene (SIS), styrene-ethylene-butylene-styrene (SEBS), styrene-butylene-styrene (SBS), and the like, ester-based elastomers, elastomeric polyurethane, elastomeric polyamide, and the like, and combinations thereof.

Thermoplastic vulcanizate compositions in accordance with the present disclosure may optionally include other elastomers, in a range from 0 phr, 1 phr, 5 phr, 10 phr, 20 phr, 50 phr, or 75 phr and an upper limit of one of 50 phr, 75 phr, 100 phr, 125 phr, or 150 phr of the thermoplastic vulcanizate compositions, where any lower limit may be combined with any mathematically compatible upper limit.

### Processing

In one or more embodiments, a thermoplastic resin and a dynamically crosslinked polymer are subjected to a melt-processing operation to form the thermoplastic vulcanizate composition.

Specifically, the thermoplastic resin and dynamically crosslinked polymer (optionally with the other component described above) may be mixed at an elevated temperature. In one or more embodiments, the processing temperature exceeds the matrix melting or softening temperature (depending on the presence of crystalline structure), as well as the suitable processing temperature for dynamically crosslinked polymer-which depends on crystallinity of the crosslinked polymer, crosslinking system, crosslinking density, etc. For example, for dynamic crosslinking comprising of transesterification reactions, generally, temperatures above 150° C. would be recommended enable good processability.

For example, a mixture of thermoplastic polymer, dynamic crosslinking agent, and catalyst may be subjected to a processing temperature greater than a processing temperature of the non-crosslinked polymer to form the thermoplastic vulcanizate composition That is, the mixture may be subjected to temperatures higher than either the melting or softening point of the non-crosslinked polymers. The temperature shall be selected according to requirements for the selected processing operation, as long as it does not exceed the polymers' degradation temperature. The softening point of an amorphous non-crosslinked polymer may be determined by the Vicat softening point method according to ASTM D-1525, and the melting point of a semi-crystalline non-crosslinked polymer may be measured by differential scanning calorimetry (DSC), according to ASTM D3418.

In one or more embodiments, thermoplastic vulcanizate compositions in accordance with the present disclosure may be prepared using continuous or discontinuous extrusion or in a continuous or batch mixing. Methods may include, but are not limited to, single-, twin- or multi-screw extruders, tangential or intermeshing internal mixers, roll mill mixers, a hot-air tunnel, an oven, a hydraulic press, an injection molding machine, an additive manufacturing machine, or an autoclave, any of which may be used at temperatures ranging from 60° C. to 270° C. in some embodiments, and from 140° C. to 230° C. in some embodiments. In some embodiments, raw materials (thermoplastic polymer, dynamically crosslinked polymer and optionally other fillers, oils, additives, etc.) are added to an extruder or other processing method, simultaneously or sequentially.

Methods of preparing polymer compositions in accordance with the present disclosure may include the general steps of combining a thermoplastic polymer, a dynamically crosslinked polymer, optionally other fillers, oils, additives, permanent crosslinking systems, etc., in an extruder or mixer; melt extruding the composition; and forming pellets, filaments, profiles, powder, bulk compound, sheets, etc. of the thermoplastic vulcanizate composition.

Thermoplastic vulcanizate compositions prepared by the present methods may be in the form of granules or other configuration that are applicable to different molding processes, including processes selected from injection or compression molding, extrusion, blow molding extrusion, additive manufacturing, or rotational molding and the like, to produce manufactured articles.

### Articles

In one or more embodiments, an article may be formed from the dynamically crosslinked polymeric composition or from the compounded material. The articles formed may be either foamed or non-foamed.

In one or more embodiments, articles may include electrical, construction, automotive, and consumer applications. Some specific articles include, but are not limited to, mechanical rubber goods (gaskets, seals, convoluted bellows, flexible diaphragms, tubings, mounts, bumpers, valves, housings, vibration isolators, plugs, connectors, caps), automotive parts (air conditioning hose cover, fuel line hose cover, vacuum tubing, vacuum connectors, seals, body plugs, bushings, protective sleeves, shock isolators), industrial hose applications (industrial tubing, hydraulic, agricultural spray, paint spray, mine hose), electrical applications (wire and cable insulation, plug, bushings, enclosures, connectors), consumer goods (sporting goods, portable kitchen appliances, business appliances, etc.

### EXAMPLES

### Example 1: Boron Centered Chemistry for Dynamic Crosslinking for Ethylene-Vinyl Acetate Copolymers

The investigation of an alternative crosslinking route to peroxide (free-radical based), with the potential of being reversible, was performed for ethylene-vinyl acetate copolymer, using triethyl borate (99%, CAS 150-46-9, supplied by Sigma Aldrich) as a dynamic crosslinking agent and Bis(acetylacetonato)dioxomolybdenum(VI) (CAS 17524-05-9, supplied by Sigma Aldrich) as a catalyst, where triethyl borate undergoes catalyzed transesterification reaction with the vinyl acetate moieties. The resulting dynamic crosslinked EVA is referred to as DXL EVA.

Prior to processing, EVA was dried in oven for approximately 16 hours at 40° C., with subsequent cooling in a dissector.

Conventional EVA (Braskem commercial grade HM728—nominal VAc content of 28 wt % and IF (190° C.@2.16 kg)=6 g/10 min—was mixed with the components displayed in Table 1 in a mixing chamber (Haake™, roller rotors), with a fill factor of 80%, initial set temperature of 80° C., where the EVA and catalyst were first fed and mixed. After complete melt/mixing (˜15 minutes), TEB was added.

TABLE 1

| Component | phr | Wt % |
|---|---|---|
| EVA HM 728 | 100.00 | 94.79 |
| TEB | 5.25 | 4.98 |
| Molybdenum catalyst | 0.24 | 0.23 |
| Total | 105.49 | 100 |

After approximately 10 minutes of mixture of TEB with the other components, the set temperature was raised to the desired temperature (145-155° C.). The TEB content displayed refers to the quantity of TEB that leads to 1 B—O bond to ⅓ of available VA sites of approximately 28 wt % VA polymer. The stoichiometry of catalyst:TEB was extracted from literature (˜2 mol %) (GUO et al, 2019—https://pubs.acs.org/doi/abs/10.1021/acs.macromol.9b02281).

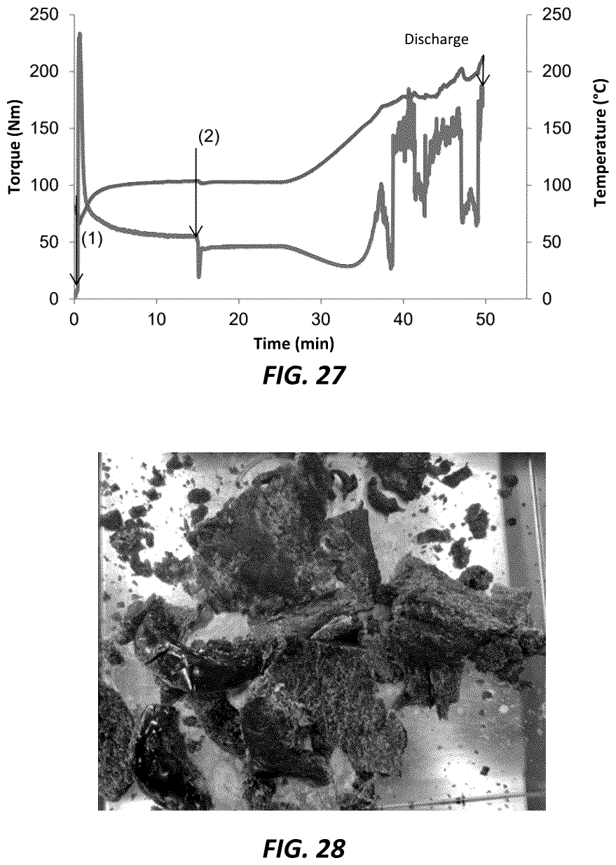

At around 150° C. (melt temperature), a clear and intense increase in the torque of the mixing chamber was observed, indicative of crosslinking reaction, which increases viscosity and elasticity of the melt. A summary of processing outputs can be seen in Table 2 and the full time vs torque and temperature is shown in FIG. 27, and an image of physical samples can be seen in FIG. 28. After that, the composition was laminated in a two-roll mill at 90° C.

TABLE 2

| | Final | Final | Final |
|---|---|---|---|
| Formulation | time (min) | temperature (° C.) | Torque (N.m) |
| Boron 5 | 50 | 212 | 190 |

### Example 2

Formulations with the aforementioned dynamic crosslinked EVA (DXL EVA) and thermoplastic matrices were compounded in a mixing chamber (Haake™, roller rotors at 190° C., 50 rpm), for ˜8-9 minutes (depending on the need of the system in order to reach torque stability without leading to degradation to the matrix), using as thermoplastic matrices polypropylene (Braskem S.A. grade H301, with a melt flow rate of 10 g/10 min (2.16 kg, 230° C.) and a density of 0.905 g/cm³)) and polyethylene (Braskem S.A. grade GE7252XP, with a melt flow rate of 2 g/10 min (2.16 kg, 190° C.) and a density of 0.952 g/cm³). In the compositions with polypropylene, a blend of antioxidant was fed as well (˜3000 ppm), consisting of 30 wt % of hindered phenolic primary antioxidant (Pentaerythritol tetrakis(3-(3,5-di-tert-butyl-4-hydroxyphenyl)propionate) and 70 wt % of secondary phosphite antioxidant (Tris(2,4-ditert-butylphenyl) phosphite).

The tested ratios of polyolefin/dynamically crosslinked EVA (DXL EVA) were (wt %/wt %): 70/30; 50/50; 40/60 and 30/70.

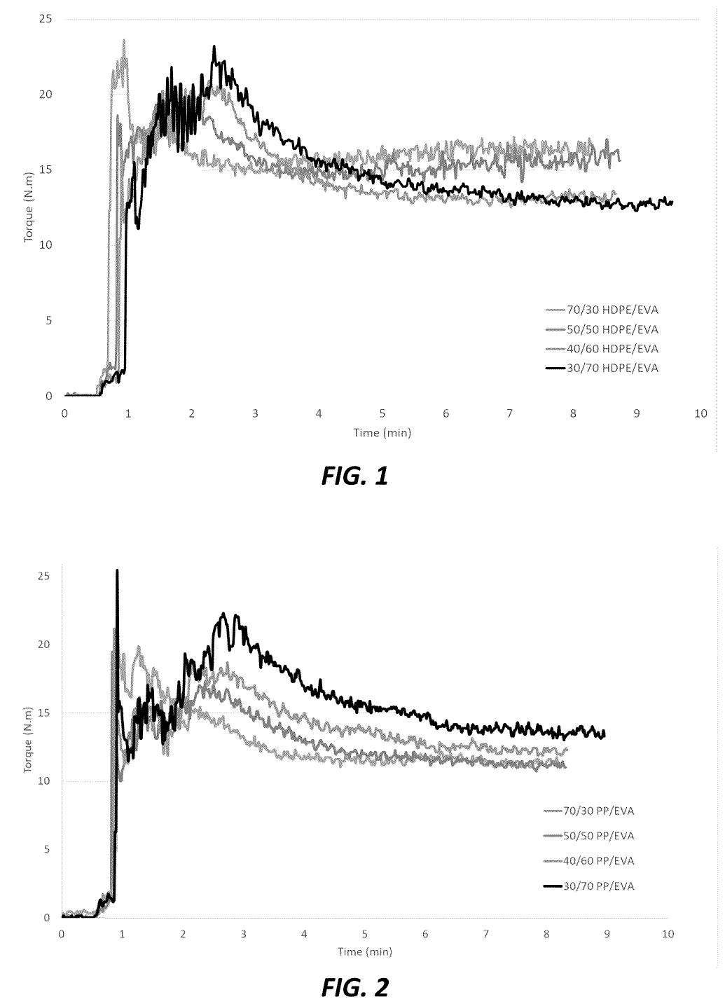

Torque plots of the aforementioned compositions are displayed in FIGS. 1 and 2, where one can observe a reasonable similarity in terms of compounding time and torque stability (which ultimately, is related to the stability of blend morphology/homogeneity).

Samples were compression molded in a Carver hydraulic press at 190° C., following ASTM D 4703-cycles of 5 mins at ˜3.5 ton, cycle of 10 mins at ˜12 ton, followed by controlled cooling (15° C./min) until below 50° C. Plates of 2 mm of thickness were molded in order to be die cut to DMA and microscopy, and disks with diameter of 25 mm and thickness of 2 mm were molded under the same conditions to rheological tests.

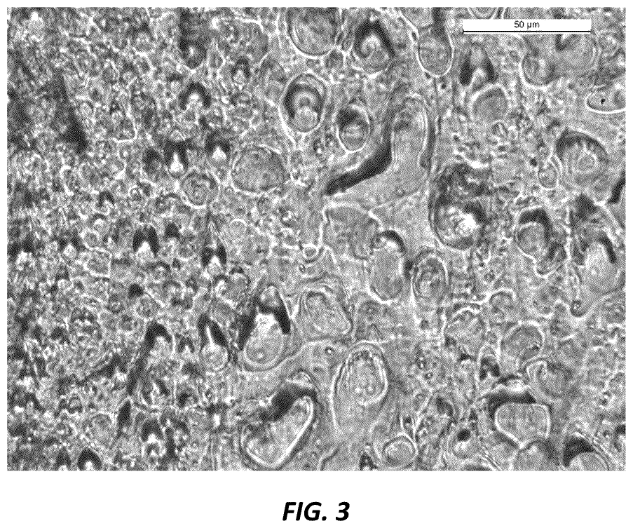

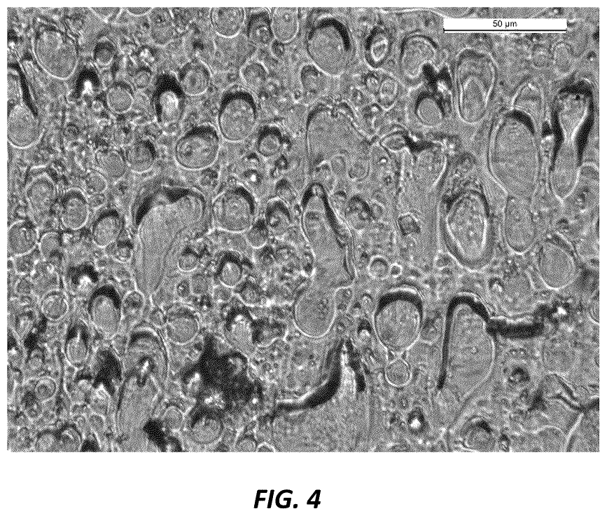

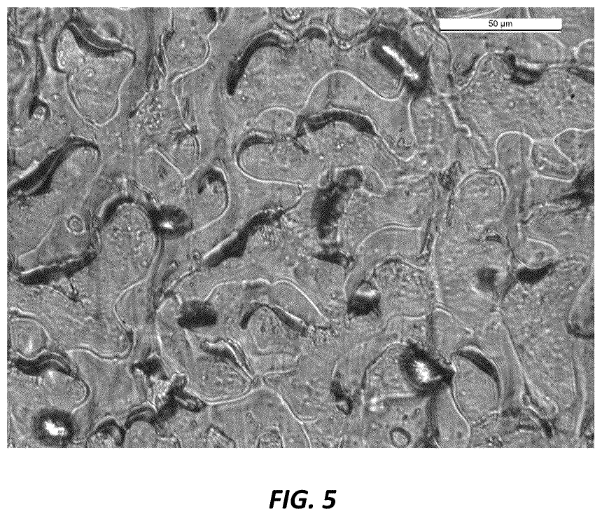

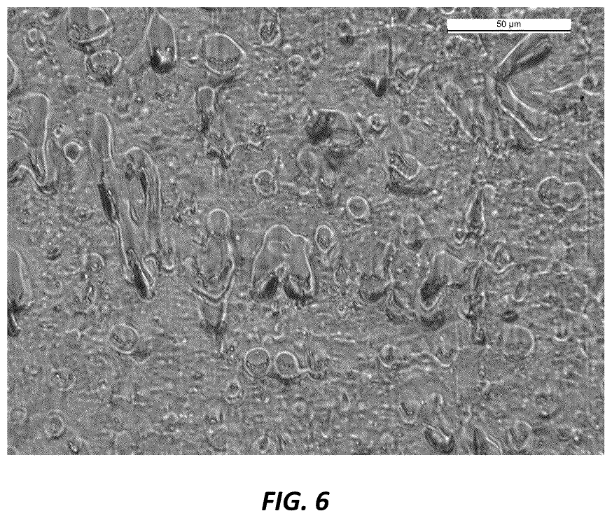

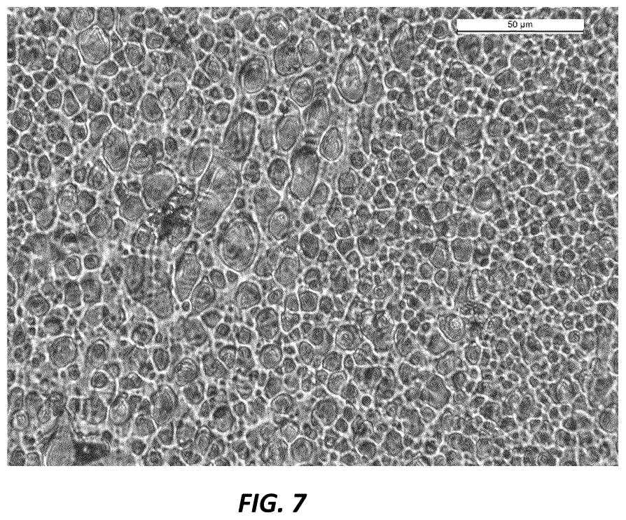

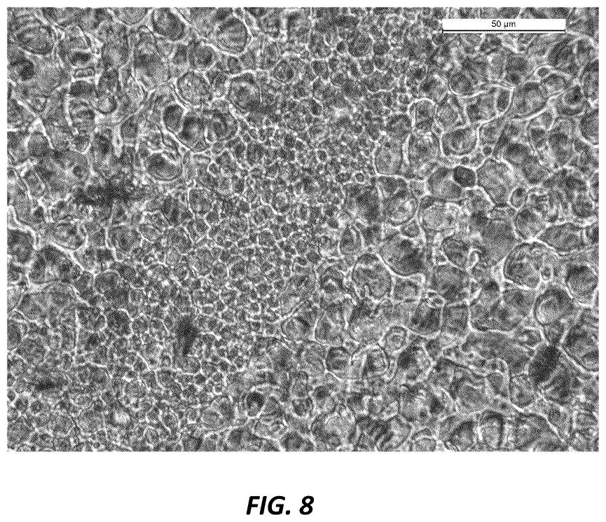

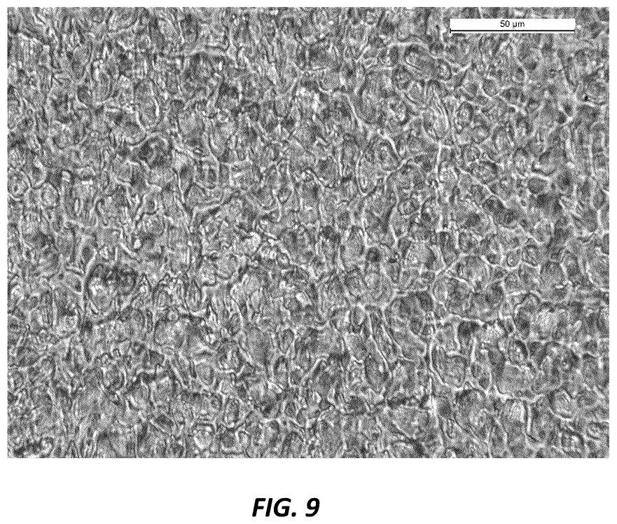

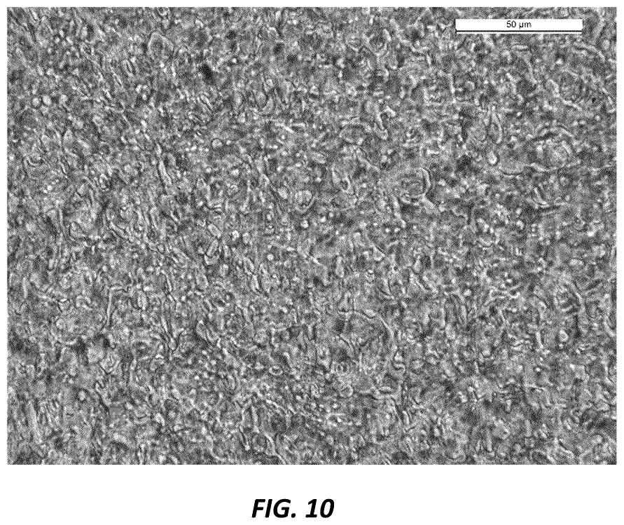

The morphology of the blends was observed via optical microscopy. Compression molded samples were first cut into ˜7 μm thick slices using a LEICA HistoCore MULTICUT microtome, and then evaluated using a LEICA DMLM optical microscope, using polarized, transmitted light. FIGS. 3 to 6 display the obtained morphology for the PP/DXL EVA blends. FIG. 3 shows the morphology of (wt %/wt %) 30/70 PP/DXL EVA. FIG. 4 shows the morphology of (wt %/wt %) 40/60 PP/DXL EVA. FIG. 5 shows the morphology of (wt %/wt %) 50/50 PP/DXL EVA. FIG. 6 shows the morphology of (wt %/wt %) 70/30 PP/DXL EVA. FIGS. 7-10 display the obtained morphology for the HDPE/DXL EVA blends. FIG. 7 shows the morphology of (wt %/wt %) 30/70 HDPE/DXL EVA. FIG. 8 shows the morphology of (wt %/wt %) 40/60 HDPE/DXL EVA. FIG. 9 shows the morphology of (wt %/wt %) 50/50 HDPE/DXL EVA. FIG. 10 shows the morphology of (wt %/wt %) 70/30 HDPE/DXL EVA.

When observing the morphology of the blends based on polypropylene, it is possible to notice an overall droplet-like morphology (with a broad droplet size distribution) for the compositions PP/DXL EVA of 30/70, 40/60 and 70/30, meanwhile, a more co-continuous character for 50/50. A similar behavior was observed for HDPE based blends, however, when comparing with the PP based blends, the droplet morphology seems to have an overall narrower size distribution, but a with less well-defined aspect for HDPE/EVA 70/30 and the proportion 50/50 displays more of a droplet morphology. Lastly, it is known that better processing conditions (e.g. the use of a twin screw extruder with the proper distribution/dispersion elements) and the use of different viscosities/elasticities ratios between the matrix and the DXL EVA, allow further tailoring of the morphology (especially leading to more regular, smaller particles with a narrow size distribution).

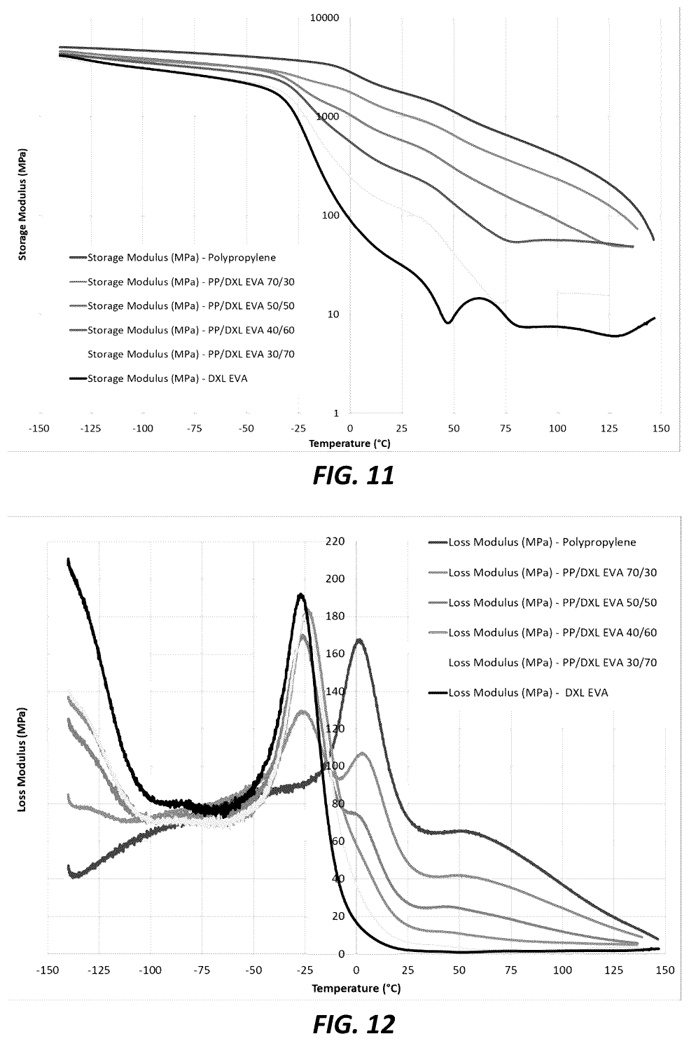

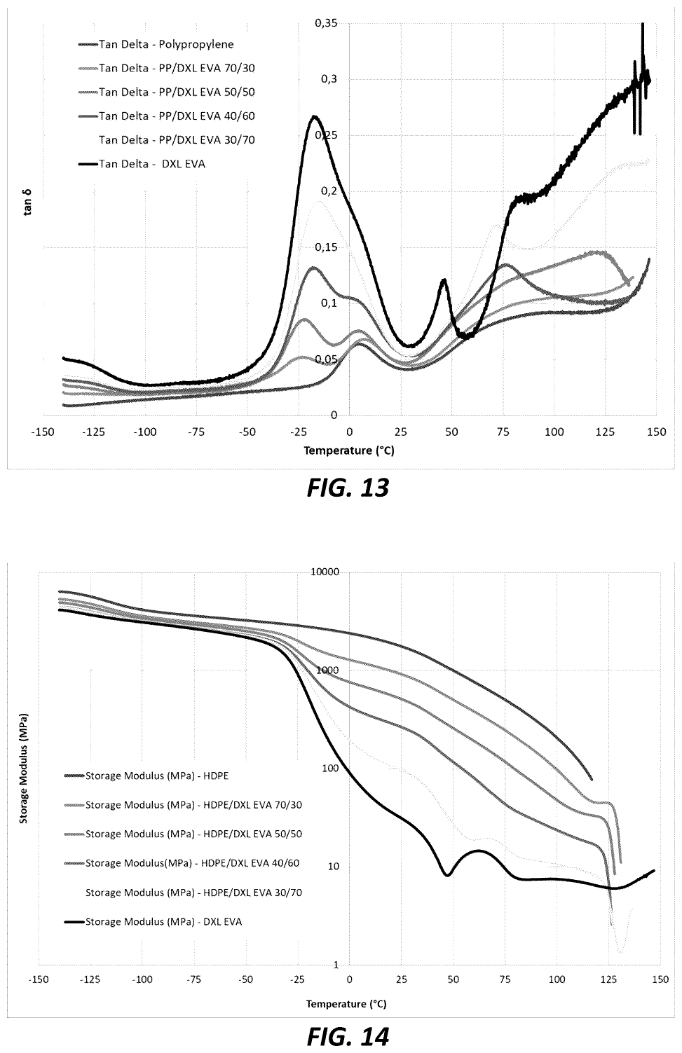

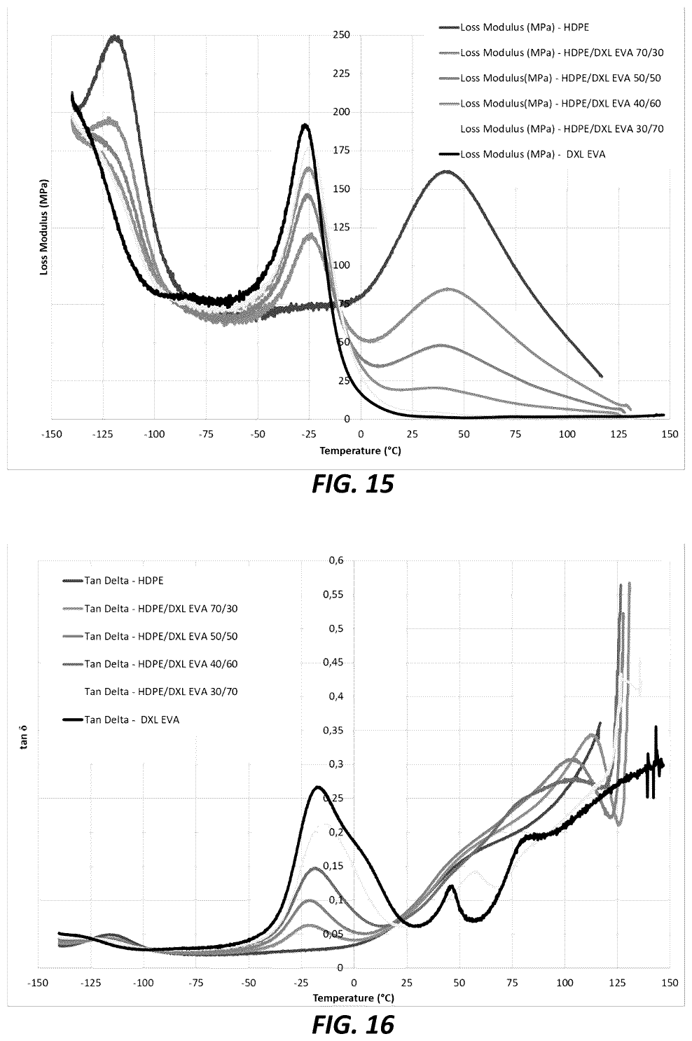

DMA analysis was carried with the goal of assessing storage modulus at room temperature (23° C.), high temperature behavior (above Tm of EVA and HDPE), and glass transition temperatures. A temperature sweep was carried with a single cantilever fixture in a TA Instruments DMA Q800, heating rate of 3° C./min, frequency of 1 Hz, deformation of 30 microns, in die cut specimens shaped as a parallelepiped with dimensions of approximately 38×13×2 mm. Results for the polypropylene based formulations are shown in FIGS. 11-13, while the results for the HDPE formulations are shown in FIGS. 14-16.

It is possible to notice for both PP and HDPE blends with DXL EVA an overall decrease in modulus, including in regions of interest—e.g. 23° C.—which means that the compound is much softer than the raw polyolefin. This feature is of main importance to a TPV, while maintaining mechanical integrity at elevated temperatures, presenting reasonable values of storage modulus at temperatures much higher than neat EVA melting point (in this case, ˜73° C.).

In addition, some variation of Tg of the EVA (which means the flexibility at low temperatures of the compound) is not significantly affected by blending with polyolefins. However, no significant detrimental effects could be observed, and formulations could be optimized in terms of low temperature flexibility upon the addition of plasticizers, if needed. In addition, PP especially led to the maintenance of a predominantly elastic behavior up to 150° C. for formulations up to 70 wt % of DXL EVA, as seen in the tan δ plot.

The results of the DMA are as summarized in Tables 3 (for polypropylene based formulations) and 4 (for HDPE based formulations).

TABLE 3

| | | PP/DXL | PP/DXL | PP/DXL | PP/DXL | DXL |
|---|---|---|---|---|---|---|
| Property | PP | EVA 70/30 | EVA 50/50 | EVA 40/60 | EVA 30/70 | EVA |
| Storage Modulus at 23° C. | 1800.00 | 1093.00 | 594.00 | 284.80 | 121.50 | 32.97 |
| (MPa) | | | | | | |
| Max at Tg EVA (Loss | — | 129.50 | 170.00 | 183.60 | 180.60 | 191.90 |
| Modulus) (MPa) | | | | | | |
| Tg EVA (Loss Modulus) | — | −26.48 | −26.00 | −23.49 | −24.15 | −27.15 |
| (° C.) | | | | | | |
| Max at Tg EVA (tan δ) | — | 0.05 | 0.09 | 0.13 | 0.19 | 0.27 |
| Tg EVA (tan δ) (° C.) | — | −22.06 | −21.95 | −18.08 | −15.27 | −17.79 |
| Max at Tg PP (Loss | 167.70 | 107.20 | 75.00 | — | — | — |
| Modulus) (MPa) | | | | | | |
| Tg PP (Loss Modulus) | 1.66 | 2.67 | −2.00 | — | — | — |
| (° C.) | | | | | | |
| Max at Tg PP (tan δ) | 0.06 | 0.07 | 0.08 | 0.10 | — | — |
| Tg PP (tan δ) (° C.) | 4.22 | 7.93 | 4.64 | 0.00 | — | — |
| Storage Modulus at 130° C. | 174.10 | 110.00 | 48.25 | 49.75 | 15.65 | 6.06 |
| (MPa) | | | | | | |

TABLE 4

| | | HDPE/DXL | HDPE/DXL | HDPE/DXL | HDPE/DXL | |
|---|---|---|---|---|---|---|
| | | EVA | EVA | EVA | EVA | DXL |
| Property | HDPE | 70/30 | 50/50 | 40/60 | 30/70 | EVA |
| Storage Modulus at | 1808.00 | 943.00 | 528.30 | 273.50 | 100.80 | 32.97 |
| 23° C. (MPa) | | | | | | |
| Max at Tg EVA (Loss | — | 121.10 | 146.50 | 163.80 | 179.70 | 191.90 |
| Modulus) | | | | | | |
| Tg EVA (Loss | — | −23.77 | −25.88 | −25.11 | −24.68 | −27.15 |
| Modulus) (° C.) | | | | | | |
| Max at Tg EVA | — | 0.06 | 0.10 | 0.15 | 0.22 | 0.27 |
| (tan δ) | | | | | | |
| Tg EVA (tan δ) (° C.) | — | −22.02 | −20.92 | −18.44 | −14.90 | −17.79 |
| Max at Tg PE (Loss | 249.60 | 196.40 | — | — | — | — |
| Modulus) (MPa) | | | | | | |
| Tg PE (Loss Modulus) | −119.46 | −122.54 | — | — | — | — |
| (° C.) | | | | | | |
| Max at Tg PE (tan δ) | 0.05 | 0.04 | 0.04 | — | — | — |
| Tg PE (tan δ) (° C.) | −116.01 | −118.26 | −118.50 | — | — | — |
| Max at PE relaxation | 161.50 | 84.98 | 48.08 | 20.46 | — | — |
| (Loss Modulus) (MPa) | | | | | | |
| PE relaxation (Loss | 40.68 | 42.16 | 38.96 | 36.63 | — | — |
| Modulus) (° C.) | | | | | | |
| Storage Modulus at | 88.79 | 48.28 | 33.79 | 17.72 | 8.76 | 6.73 |
| 115° C. (MPa) | | | | | | |

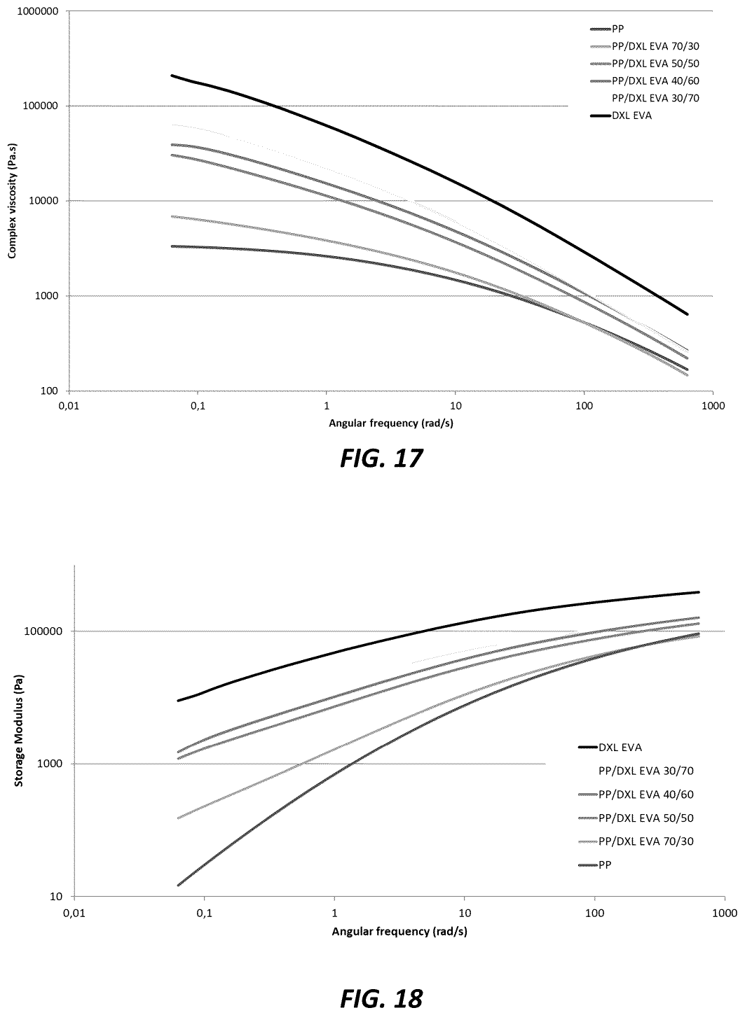

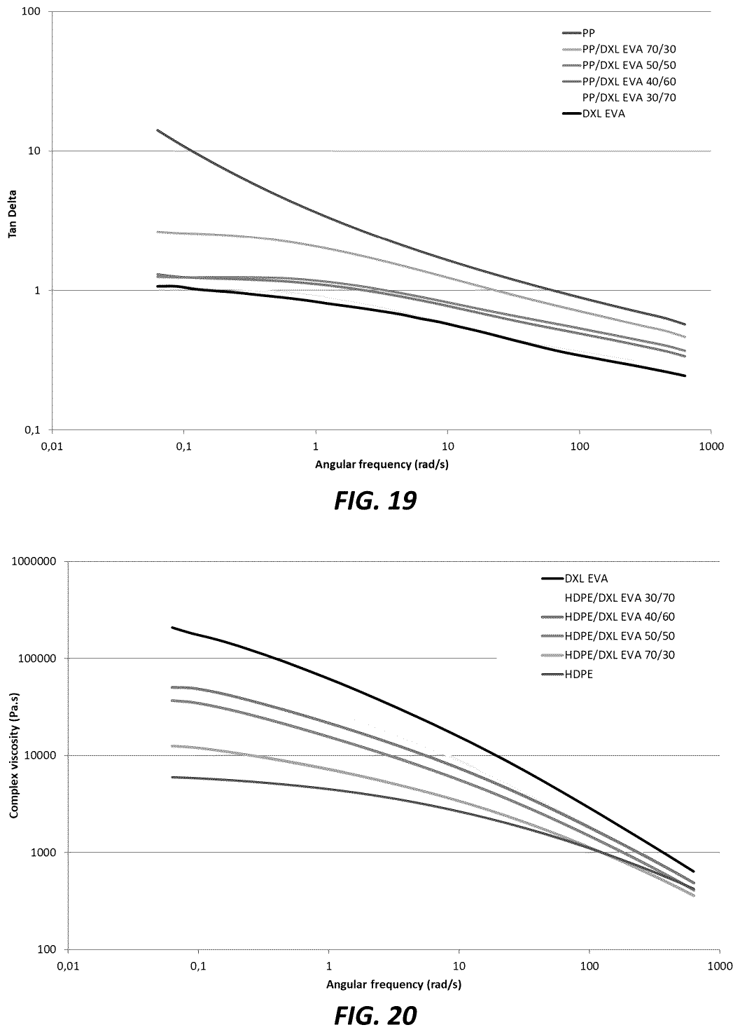

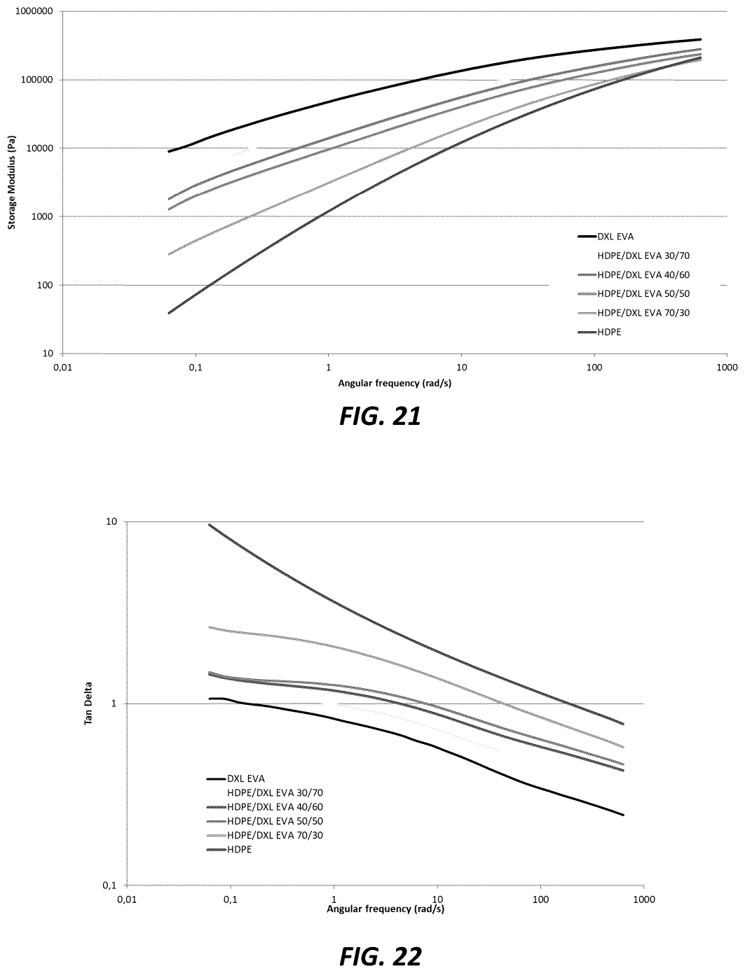

Rheological properties were measured in an oscillatory rheometer, in a small angle oscillatory shear (SAOS) regimen, using a rheometer Discovery HR-2 from TA Instruments. A frequency sweep (from 0.0628 to 628.32 rad/s) at 190° C., under constant set stress of 100 Pa (which is within LVR), with a gap of approximately 1.3 mm was carried. Results for the polypropylene based formulations are shown in FIGS. 17-19, while the results for the HDPE formulations are shown in FIGS. 20-22.

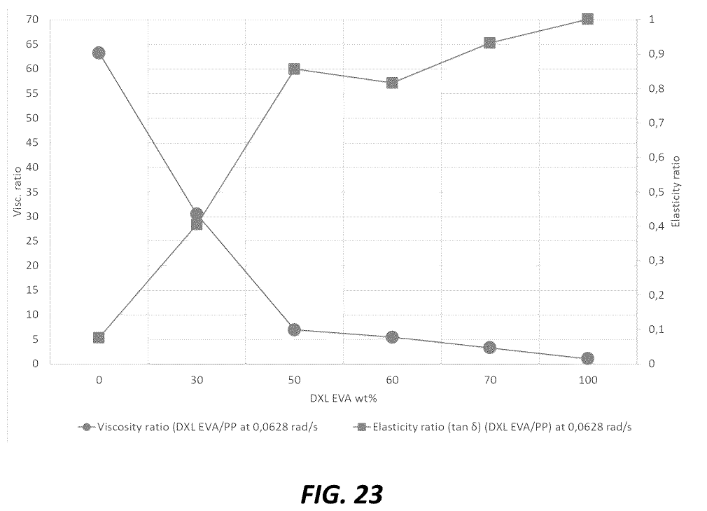

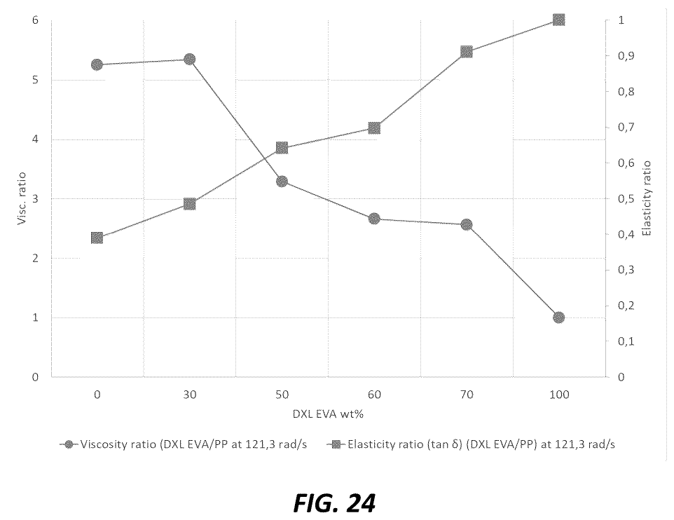

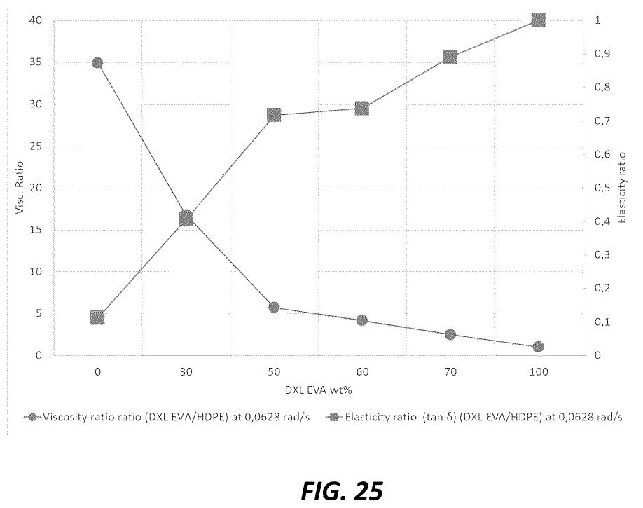

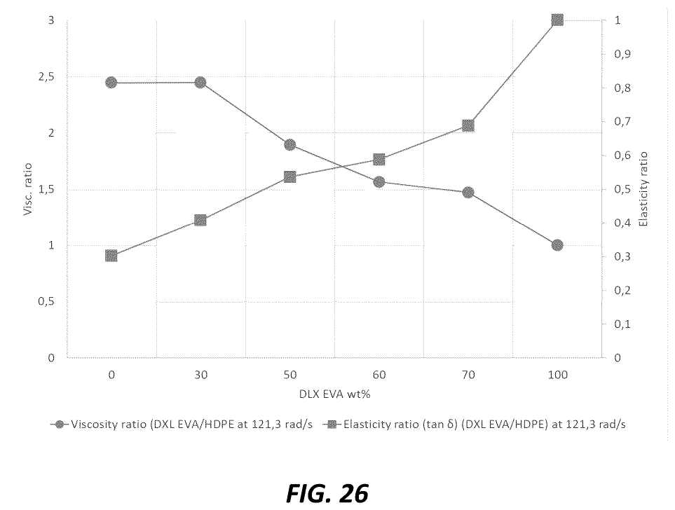

In terms of SAOS rheology, as expected, the addition of DXL EVA led to a substantial increase in melt viscosity, storage modulus and elasticity (decreasing tan δ), being that increase proportional to the wt % of DXL EVA. In addition, as seen in FIGS. 23-26, when looking to the final viscosity ratios of the mixture and comparing the neat separate materials and their blends, it is clear that the difference between DXA EVL and the polyolefins (HDPE and PP) became much smaller at higher angular frequencies (i.e. shear rate—0.0628 vs 121.3 rad/s), which means that melt processing of the mixtures is likely to be successful in equipment with high shear rates, such as extrusion and injection molding.

For the low frequency regimen (which better reflects morphology and molecular weight distribution), for both PP and HDPE, the effect of DXL EVA content over viscosity of the polymers depends more intensely up to 50 wt % (in relatively linear manners). After that, the rheological properties dependence on DXL EVA content become less intense, while still behaving quite linearly.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polymer blend composition, comprising
from 0.01 to 99.99 wt % of a thermoplastic resin matrix; and
from 0.01 to 99.99 wt % of a dynamically crosslinked polymer.

2. The polymer blend composition of claim 1, wherein the thermoplastic resin matrix comprises at least one polymer selected from the group consisting of polyolefins; acrylonitrile butadiene styrene (ABS) and other styrenics co and terpolymers; cellulosic thermoplastics; polyacrylamides and copolymers of acrylamides; polystyrene and derivatives; thermoplastic polyurethanes; fluoroplastics; polyamides; aromatic polyamides; polyketones; polybutene; polycarbonate; polyacetals; poly(vinyl acetate); polyesters; polyethylene oxide, polypropylene oxide, polyphenylene oxide; polyphenylene sulphide; polymethylpentene; poly(vinyl alcohol); ethylene vinyl alcohol (EVOH) copolymers; polyvinyl chloride; styrene acrylonitrile and acrylonitrile styrene acrylate; thermoplastic elastomers; and combinations thereof.

3. The polymer blend composition of claim 2, wherein the thermoplastic resin matrix comprises a polyolefin and wherein the polyolefin is selected from the group consisting of polyethylene, polypropylene, ethylene-vinyl acetate copolymer, ethylene based co- and terpolymers, and combinations thereof.

4. The polymer blend composition of claim 1, wherein the thermoplastic resin matrix is derived from a fossil feedstock, renewable feedstock, a virgin feedstock or recycled materials.

5. The polymer blend of claim 1, wherein the dynamically crosslinked polymer is in a dispersed phase in the thermoplastic resin.

6. The polymer blend of claim 1, wherein the dynamically crosslinked polymer comprises at least one monomer selected from the group consisting of vinyl esters, C2-C12 olefins, and combinations thereof, and a dynamic crosslinking group, and is crosslinked by a dynamic crosslinking system.

7. The polymer blend of claim 6, wherein:
the dynamic crosslinking group is selected from the group consisting of esters, epoxides, organic acids, alcohols, anhydrides, amines, amides, cyanates, unsaturated hydrocarbons and combinations thereof, and
the dynamic crosslinking system comprises a dynamic crosslinking agent and a catalyst, wherein the dynamic crosslinking agent is selected from the group consisting of borates, silanes, polyamines, polyols, polyacids, anhydrides, and combinations thereof, and the catalyst is a transesterification catalyst or it is selected from the group consisting of o-nucleophiles; n-nucleophiles; metal oxides; metal hydroxides; organic metal salts selected from the group consisting of acetylacetonates, diacrylates, carbonates, acetates and combinations thereof, and wherein the metal is selected from the group consisting of Zinc, Molybdenum, Copper, Magnesium, Sodium, Potassium, Calcium, Nickel, Tin, Lithium, Titanium, Zirconium, Aluminum, Lead, Iron, Vanadium, and combinations thereof.

8. The polymer blend composition of claim 1, wherein the dynamically crosslinked polymer is EVA.

9. The polymer blend composition of claim 1, wherein the dynamically crosslinked polymer is from a fossil or renewable feedstock.

10. A thermoplastic vulcanizate composition comprising:
the polymer blend composition of claim 1;
from 0 to 150 phr of plasticizer; and
from 0 to 600 phr of at least one filler.

11. An article comprising the polymer blend composition of claim 1.

12. An article comprising the thermoplastic vulcanizate composition of claim 10.

13. The article of claim 11, wherein the article is formed by injection or compression molding, extrusion, blow molding extrusion, additive manufacturing, or rotational molding.

14. The article of claim 12, wherein the article is formed by injection or compression molding, extrusion, blow molding extrusion, additive manufacturing, or rotational molding.

15. A method, comprising:
blending a thermoplastic resin and a dynamically crosslinked polymer to form the polymer blend composition of claim 1.

16. The method of claim 15, wherein during the blending, the dynamically crosslinked polymer is crosslinked.

17. The method of claim 15, further comprising: compounding at least one of plasticizer and/or filler in the blending step or after the blending step to form a thermoplastic vulcanizate composition.

18. The method of claim 17, wherein the blending occurs in a batch or continuous mixer.

19. A method of forming an article, comprising: processing the polymer blend composition of claim 1, wherein the processing comprises injection or compression molding, extrusion, blow molding extrusion, additive manufacturing, or rotational molding.

20. A method of forming an article, comprising: processing the thermoplastic vulcanizate composition of claim 10, wherein the processing comprises injection or compression molding, extrusion, blow molding extrusion, additive manufacturing, or rotational molding.
